(19) United States
(12) Patent Application Publication
(10) Pub. No.: US 2014/0237060 A1
(43) Pub. Date: Aug. 21, 2014

(54) SYSTEM AND METHOD FOR PROVIDING INTELLIGENT USERNAME IN STATUS UPDATES

(71) Applicant: MOTOROLA MOBILITY LLC, Libertyville, IL (US)

(72) Inventors: Lisa N. Reed, Los Altos, CA (US); Bryan C. Gebhardt, Fremont, CA (US); Scott I. Putterman, Cupertino, CA (US); Sejal Shah, San Jose, CA (US); Sunny Y. Yang, San Francisco, CA (US)

(73) Assignee: MOTOROLA MOBILITY LLC, Libertyville, IL (US)

(21) Appl. No.: 14/184,729

(22) Filed: Feb. 20, 2014

Related U.S. Application Data
(60) Provisional application No. 61/766,896, filed on Feb. 20, 2013.

(51) Int. Cl. H04L 12/58

(52) U.S. Cl. CPC H04L 51/32
USPC 709/206

(57) ABSTRACT

Embodiments provide a system and method of using a universal tagged communication for social networks. A user could insert a contact from multiple social networking sources. As the communication is transmitted, the actual text sent to each social networking service changes depending on how that service supports this tagging. A tagging component may generate new tagging formats for each associated social network.

### FIELD OF DISCLOSURE

Embodiments of the present disclosure relate to individual identifiers in social networking websites.

### BACKGROUND

One feature of many social networks is “social bookmarking,” which includes “tagging.” Social bookmarking is a method for Internet users to organize, store, manage and search for bookmarks of resources online. Unlike file sharing, the resources themselves aren't shared, merely bookmarks that reference them.

Descriptions may be added to these bookmarks in the form of metadata, so users may understand the content of the resource without first needing to download it for themselves. Such descriptions may be free text comments, votes in favor of or against its quality, or tags that collectively or collaboratively become a folksonomy. Folksonomy is also called social tagging, “the process by which many users add metadata in the form of keywords to shared content.”

In a social bookmarking system, users save links to web pages that they want to remember and/or share. These bookmarks are usually public, and can be saved privately, shared only with specified people or groups, shared only inside certain networks, or another combination of public and private domains. The allowed people can usually view these bookmarks chronologically, by category or tags, or via a search engine.

Most social bookmark services encourage users to organize their bookmarks with informal tags instead of the traditional browser-based system of folders, although some services feature categories/folders or a combination of folders and tags. They also enable viewing bookmarks associated with a chosen tag, and include information about the number of users who have bookmarked them. Some social bookmarking services also draw inferences from the relationship of tags to create clusters of tags or bookmarks. metadata helps describe an item and allows it to be found again by browsing or searching.

A tag may typically be a non-hierarchical keyword or term assigned to a piece of information (such as an Internet bookmark, digital image, or computer file). This kind of Tags are generally chosen informally and personally by the item's creator or by its viewer, depending on the system.

### BRIEF SUMMARY OF THE DRAWINGS

The accompanying drawings, which are incorporated in and form a part of the specification, illustrate example embodiments of the present disclosure and, together with the description, serve to explain the principles of the disclosure. In the drawings:

FIG. 1 illustrates a prior art system including a communication network in combination with a plurality of social networks;

FIGS. 2A-2B illustrates example prior art methods of communicating in the communication network in combination with a plurality of social networks, of FIG. 1;

FIG. 3 illustrates another system including a communication network in combination with a plurality of social networks;

FIG. 4 illustrates an example method of communicating in the communication network in combination with a plurality of social networks, of FIG. 1, in accordance with embodiments of the present disclosure;

FIG. 5 illustrates block diagram of an example translator/distributor in accordance with embodiments of the present disclosure;

FIG. 6 illustrates an example method of operation of the translator/distributor of FIG. 5; and

FIG. 7 illustrates an example memory component of the translator/distributor of FIG.

### DETAILED DESCRIPTION

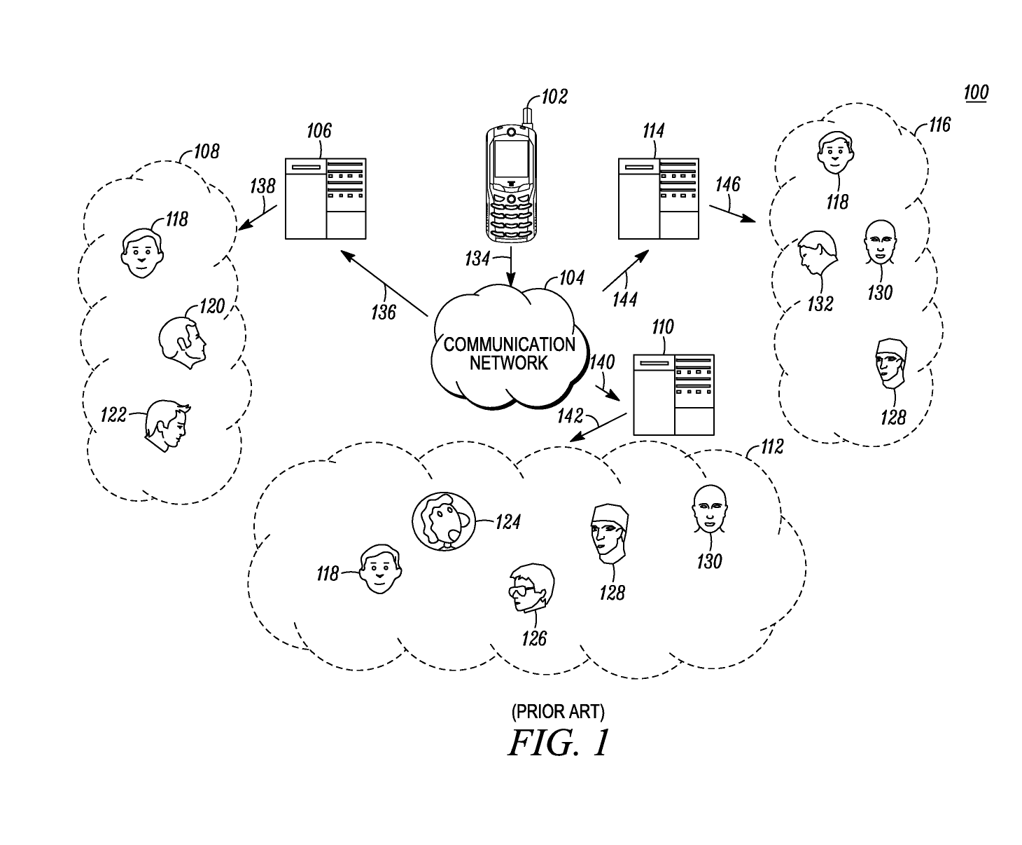

Users of various social networks have multiple sources where they want to post status updates. However, certain social networking services have unique features. One of these is tagging other users in updates. This will be described below with reference to FIGS. 1-3.

FIG. 1 illustrates a system 100 including a communication network in combination with a plurality of social networks.

As shown in the figure, system 100 includes a user device 102, a communication network 104, a first server 106, a second server 110, a third server 114, a first group of users 108, a second group of users 112, and a third group of users 116. First group of users 108 includes a user 118, a user 120, and a user 122. Second group of users 112 includes user 118, a user 124, a user 126, a user 128, and a user 130. Third group of users 116 includes user 118, user 128, user 130, and a user 132.

User device 102 is arranged to be in bi-directional communication with communication network 104, which is arranged to be in bi-directional communication with first server 106, second server 110, and third server 114. First server 106 is arranged to be in bi-directional communication with first group of users 108. Second server 110 is arranged to be in bi-directional communication with second group of users 112. Third server 114 is arranged to be in bi-directional communication with third group of users 116.

Communication network 104 may be any known type of communication network, non-limiting examples of which may include Ethernet, optical fiber, Local Area Network (LAN), Wireless LAN (WLAN), Internet, cable, public switched telephone network (PSTN), cellular, satellite, and power line.

Each of server 106, 110, and 114 is a server that serves a social network. For purposes of discussion, a social network may be a social structure made up of a set of actors (such as individuals or organizations) and the dyadic ties between these actors. The social network perspective provides a clear way of analyzing the structure of whole social entities.

For purposes of discussion, let server 106 be a server on a social network website called “First Social Network”, wherein users may open respective accounts on the server to, among other things, send/receive messages. An example social network is FaceTime™. Now, let a person Tim have account with First Social Network. In this example, let Tim be accessing his account via user device 102. Further, let Tim have many friends with accounts in First Social Network. These friends correspond to first group of users 108, which includes user 118, user 120, and user 122. In this example, a user, e.g. user 118, may be considered a user account within the social network First Social Network, wherein the associated server, in this example server 106, may provide/receive messages to/from that user account. Accordingly, user 118, user 120, and user 122 are not actual people, but are accounts that may be accessed by owners of the accounts using known devices, such as smart phones, tablets, computers, etc. In this example, let the owner of the account for user 118 be Jenny, let the owner of the account for user 120 be Bill and let the owner of the account for user 122 be Bob.

Similarly, for purposes of discussion, let server 110 be a server on a social network website called Second Social Network, and let server 114 be a server on a social network website called Third Social Network. For example, the second social network could be LinkedIn™ and the third social network could be Twitter. The specific social network for the First, Second, and Third Social Network is not critical, but rather these are provided solely for purposes of illustration by way of example. Now, let Tim have account with Second Social Network and Third Social Network. Further, let Tim have many friends with accounts in Second Social Network. These friends correspond to second group of users 112, which includes user 118, user 124, user 126, user 128, and user 130. In this example, let the owner of the account for user 118 be Jenny, let the owner of the account for user 124 be Dana, let the owner of the account for user 126 be Kevin, let the owner of the account for user 128 be Frank, and let the owner of the account for user 130 be Jeff.

Still further, let Tim have many friends with accounts in Third Social Network. These friends correspond to third group of users 116, which includes user 118, user 128, user 130, and user 132. In this example, let the owner of the account for user 118 be Jenny, let the owner of the account for user 128 be Frank, let the owner of the account for user 130 be Jeff, and let the owner of the account for user 132 be Betty.

In this example, it is clear that user 118 is a friend of Tim via each of servers 106, 110, and 114. Similarly, users 128, and 130 are friends with Tim via servers 110 and 114.

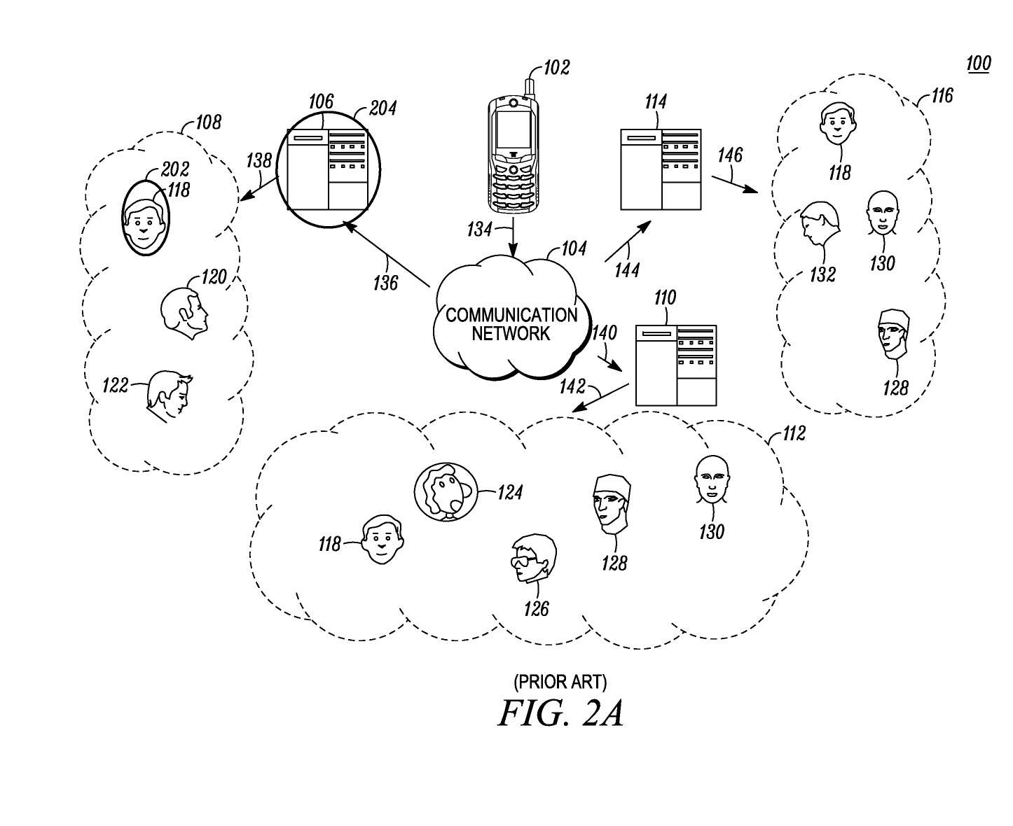

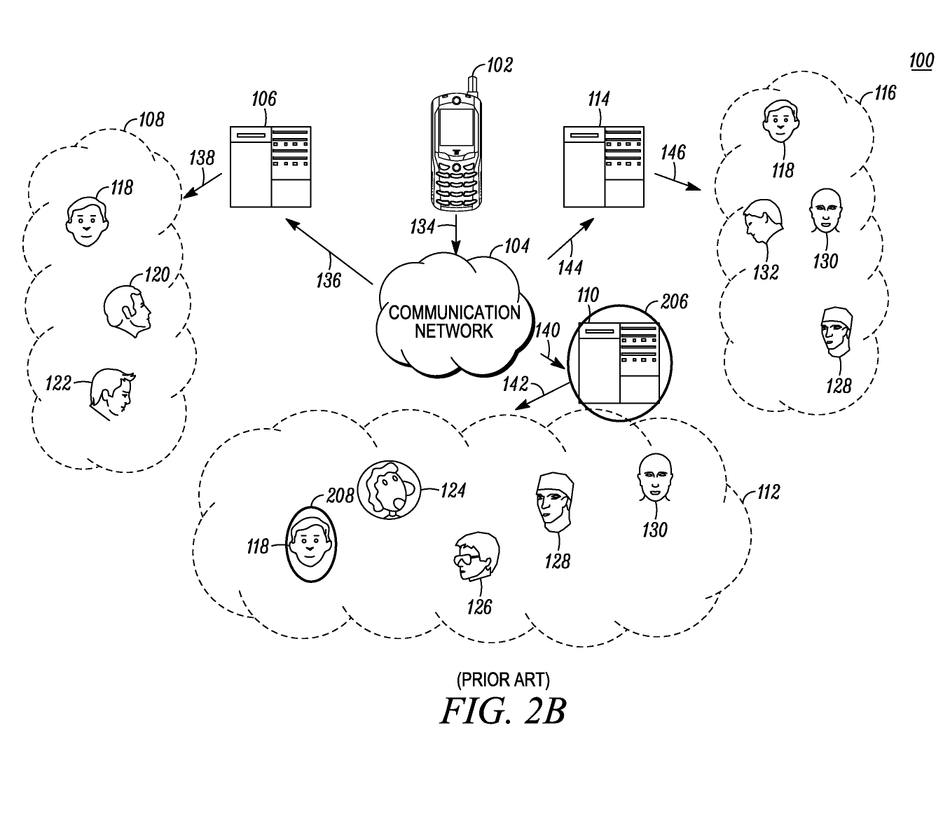

As for an example of tagging, consider the situation where the user of user device 102 would like to tag a friend in one of the user's social networks. For example, take the case where the user of user device 102 would like to post a comment to his friend Jenny, and tag the comment, so that Jenny will be notified of the comment. This will now be described with reference to FIGS. 2A-2B.

FIGS. 2A-2B illustrates example prior art methods of communicating in the communication network in combination with a plurality of social networks, of FIG. 1.

FIG. 2A illustrates the example situation where the user of user device 102 tags Jenny in the social network corresponding to server 106. In this example, let the tagging format for users of server 106 include the “@” symbol. As such, the tagging format to tag a communication for Jenny is “@Jenny.” User device 102 transmits a tagged communication 134 to communication network 104. As indicated by arrow 136, communication network 104 forwards tagged communication 134 to server 106, as indicated by shaded circle 204. As indicated by arrow 138, server 106 provides tagged communication to first group of users 108. As indicated by shaded portion 202, user 118 (Jenny) is notified of the tagged communication.

A user of user device 102 may want to post comments or pictures to others within a particular social network, say for example all users within group of users 108. If the user of user device 102 wants to direct attention to a particular user within group of users 108, then the user of user device 102 may tag the communication (the comment or picture). For example, say that the user of user device 102 posts a picture of a person Jenny, who corresponds to user 118 of group of users 108. If the user of user device 102 really wants Jenny to view the picture, the user of user device 102 may tag the communication (in this case the picture of Jenny) with a tag associated with user 118. The tag will alert user 118 within group of users 108 of the communication, thus increasing likelihood that Jenny will view the communication. If there is no tag, then the communication may be lost in the myriad of other posts with which everyone within group of users 108 views. Accordingly, the communication (the picture itself) may seem less important Jenny. In such a case, there is less likelihood that Jenny will see the picture. As such, tagging may be important feature to the user of user device 102.

In this example, the tagging format is specific to the server, and thus to the associated group of people. If the user of user device 102 would like to send the message to Jenny through another social network, for example to server 110 to group of users 112, then a new message with new type of tagging format may be sent. The tagging of a new message type within a second social network will now be described with reference to FIG. 2B.

FIG. 2B illustrates the example situation where the user of user device 102 tags Jenny in the social network corresponding to server 110. In this example, let the tagging format for users of server 110 include the “#” symbol. As such, the tagging format to tag a communication for Jenny is “#Jenny.” User device 102 transmits a tagged communication 134 to communication network 104. As indicated by arrow 140, communication network 104 forwards tagged communication 134 to server 110, as indicated by shaded circle 206. As indicated by arrow 142, server 110 provides a tagged communication to second group of users 112. As indicated by shaded portion 208, user 118 (Jenny) is notified of the tagged communication.

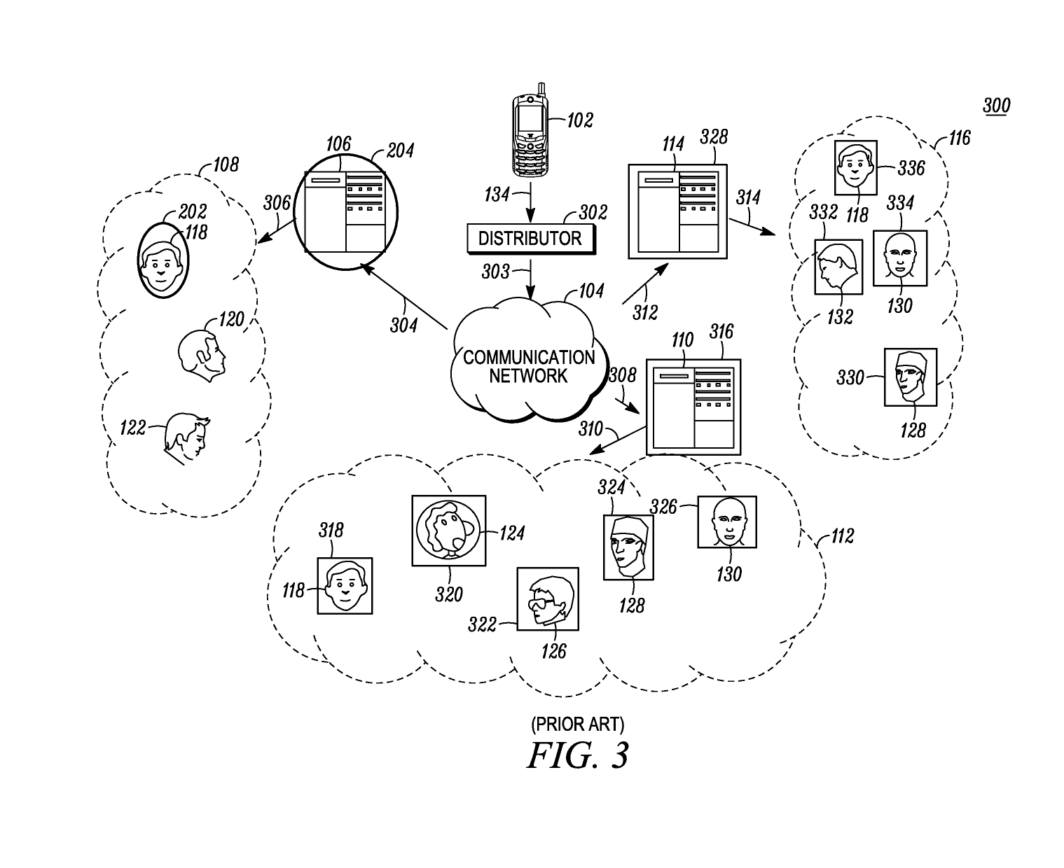

Now, suppose that the user of user device 102 desires send a single tagged communication to Jenny for all social networks. A conventional method for such a communication will be described with reference to FIG. 3.

FIG. 3 illustrates another system including a communication network in combination with a plurality of social networks.

As shown in FIG. 3, system 300 includes all the elements of system 100 of FIG. 1, with the addition of a distributor 302.

Distributor 302 is arranged to bidirectionally communicate with user device 102, and to birectionally communicate with each of server 106, server 110, and server 114, via communication network 104. Here, distributor is able to send a tagged communication to each of servers 106, 110, and 114. However, the actual tagging will only be recognized by one of the servers.

FIG. 3 illustrates the example situation where the user of user device 102 tags Jenny in the social network corresponding to server 106, but transmits the communication to each of server 106, 110, and 114. In this example, again, the tagging format to tag a communication for Jenny is “@Jenny.” User device 102 transmits a tagged communication 134 to distributor 302. Distributor 302 transmits a distributed communication 303 to communication network 104.

Similar to FIG. 2A, as indicated by arrow 304, communication network 104 forwards tagged communication 134 to server 106, as indicated by shaded circle 204. As indicated by arrow 138, server 106 provides tagged communication to first group of users 108. As indicated by shaded portion 202, user 118 (Jenny) is notified of the tagged communication.

Contrary to FIG. 2B, in this case, as indicated by arrow 308, communication network 104 forwards tagged communication 134 to server 110, as indicated by shaded rectangle 316. In this situation, server 110 does not recognize the tag, as the tagging format is the format recognized only by server 106. In other words, although tagged communication 134 was “tagged,” it is only a communication with respect to server 110. As indicated by arrow 310, server 110 provides the communication as more of a news feed to second group of users 112. Here, all users view the communication, as indicated by shaded portions 318, 320, 322, 324, and 326.

Similarly, as indicated by arrow 312, communication network 104 forwards tagged communication 134 to server 114, as indicated by shaded rectangle 328. In this situation, server 114 does not recognize the tag, as the tagging format is the format recognized only by server 106. As indicated by arrow 314, server 114 provides the communication as more of a news feed to third group of users 116. Here, all users view the communication, as indicated by shaded portions 330, 332, 334, and 336.

In this situation, jenny might not pay attention to message if viewing through 112 or 116, as tagging is not effective.

Example embodiments of the present disclosure provide a system and method to provide a universal tag that is effective.

One embodiment is drawn to a device comprising a communication component, a memory component, a determining component, and a tagging component. The communication component can receive a tagged communication from a communication device, wherein the tagged communication is in a first tagging format and has identification data associated with one user of a first group of users. The memory component can store first identification data of the first group of users and can store second identification data of a second group of users. The first identification data includes first ID data corresponding to each user of the first group of users, respectively, whereas the second identification data includes second ID data corresponding to each user of the second group of users, respectively. The determining component can determine whether the one of the first group of users has corresponding identification data within the second identification data. The tagging component can generate a modified tagged communication based on the tagged communication, wherein the modified tagged communication is in a second tagging format. The communication component can further transmit the tagged communication to a first server and can transmit the modified tagged communication to a second server.

Another embodiment is drawn to a device comprising a communication component, a memory component, a determining component, and a tagging component. The communication component can generate a tagged communication, wherein the tagged communication is in a first tagging format and has identification data associated with one user of a first group of users. The memory component can store first identification data of the first group of users and can store second identification data of a second group of users. The first identification data includes first ID data corresponding to each user of the first group of users, respectively, whereas the second identification data includes second ID data corresponding to each user of the second group of users, respectively. The determining component can determine whether the one of the first group of users has corresponding identification data within the second identification data. The tagging component can generate a modified tagged communication based on the tagged communication, wherein the modified tagged communication is in a second tagging format. The communication component can further transmit the tagged communication to a first server and can transmit the modified tagged communication to a second server.

In some embodiments, the memory component includes a look-up table. In some embodiments, at least two of the communication component, the memory component, the determining component, and the tagging component comprise a unitary device.

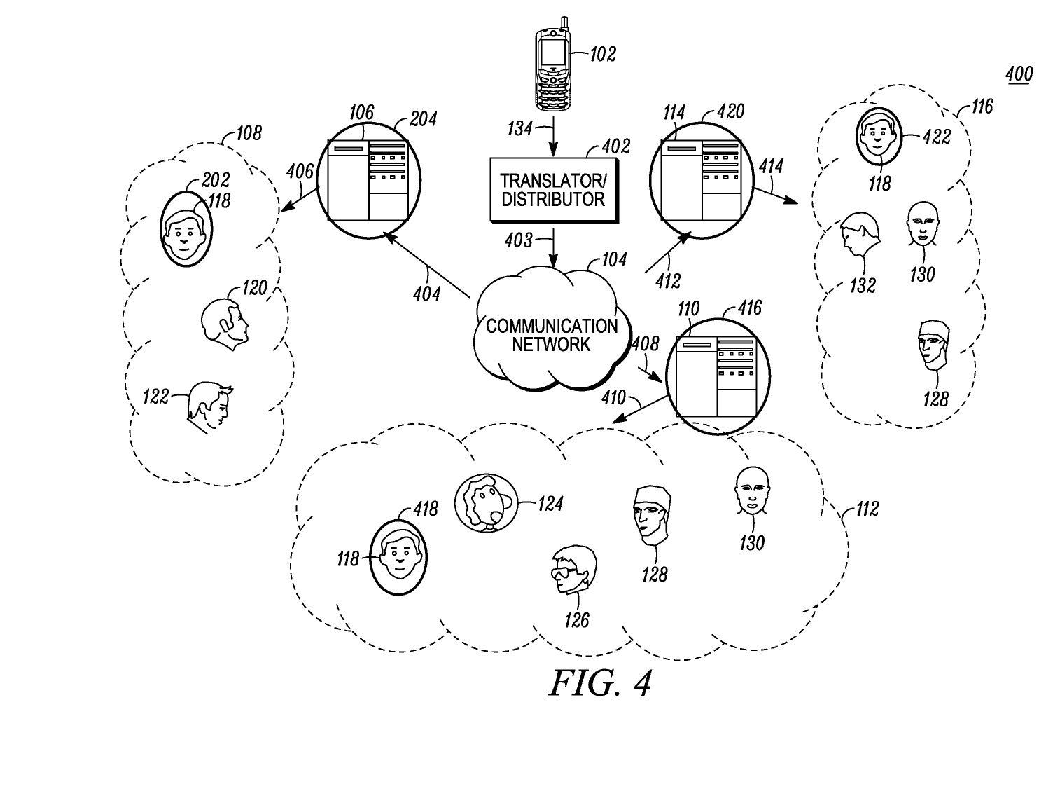

Example embodiments will now be described with reference to FIGS. 4-7.

FIG. 4 illustrates an example method of communicating in the communication network in combination with a plurality of social networks, of FIG. 1, yet in accordance with embodiments of the present disclosure.

As shown in FIG. 4, system 400 is similar to system 300 of FIG. 3, but differs in that distributor 302, has been replaced with a translator/distributor 402.

Translator/distributor 402 is arranged to bidirectionally communicate with user device 102, and to birectionally communicate with each of server 106, server 110, and server 114, via communication network 104.

FIG. 4 illustrates the example situation where the user of user device 102 tags Jenny in the social network corresponding to each of server 106, server 110, and server 114. User device 102 transmits a tagged communication 134 to translator/distributor 402. Translator/distributor 402 transmits a distributed communication 403 to communication network 104.

Similar to FIG. 2A, as indicated by arrow 404, communication network 104 forwards tagged communication 134 to server 106, as indicated by shaded circle 204. As indicated by arrow 406, server 106 provides tagged communication 134 to first group of users 108. As indicated by shaded portion 202, user 118 (Jenny) is notified of the tagged communication.

Contrary to FIG. 3, in this case, as indicated by arrow 408, communication network 104 forwards a first modified version of tagged communication 134 (or a first modified tagged communication) to server 110, as indicated by shaded circle 416. In this situation, server 110 recognizes the tag. As indicated by arrow 410, server 110 provides the first modified tagged communication to second group of users 112. As indicated by shaded portion 418, user 118 (Jenny) is notified of the first modified tagged communication.

Similarly, as indicated by arrow 412, communication network 104 forwards a second modified version of tagged communication 134 (or a second modified tagged communication) to server 114, as indicated by shaded circle 420. In this situation, server 114 recognizes the tag. As indicated by arrow 414, server 114 provides the second modified tagged communication to third group of users 116. As indicated by shaded portion 422, user 118 (Jenny) is notified of the second modified tagged communication.

In accordance with this embodiment, no matter which social network Jenny visits, she will be notified of the original tagged communication. In the conventional method discussed above with reference to FIG. 3, in the social network associated with group of users 112 and the social network associated with group of users 116, the original tagged communication does not accurately indicated to user 118 that she was tagged. On the contrary, in embodiments of the present disclosure, as shown in FIG. 4, Jenny will be notified of the original tagged communication whether she visits the social network associated with group of users 108, the social network associated with group of users 112 or the social network associated with group of users 116.

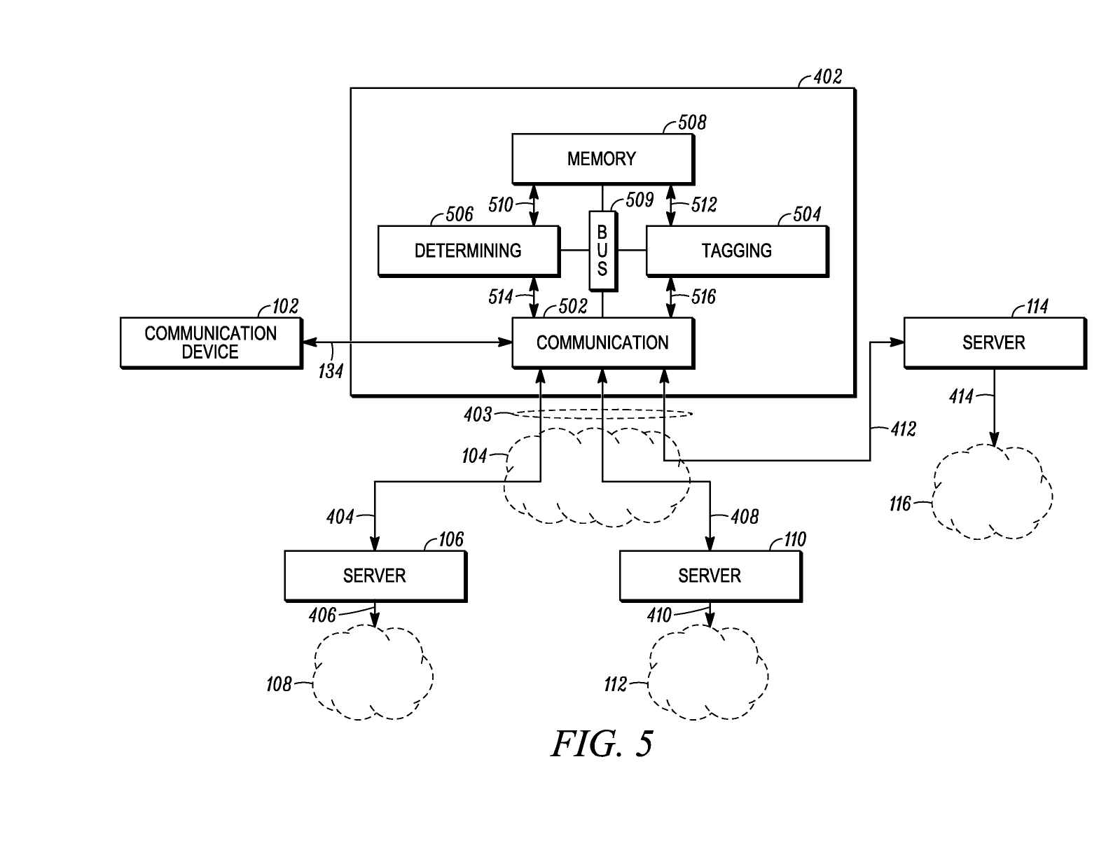

Operation of translator/distributor 402 will now be further described with reference to FIGS. 5-7.

FIG. 5 illustrates block diagram of an example translator/distributor of FIG. 4.

As shown in the figure, translator/distributor 402 includes a communication component 502, a tagging component 504, a determining component 506, a memory component 508, and a communication bus 509. In this example, each of communication component 502, tagging component 504, determining component 506, memory component 508, and communication bus 509 are distinct devices. However, in other embodiments, at least two of communication component 502, tagging component 504, determining component 506, memory component 508, and communication bus 509 may be combined as a unitary device. Further, in some embodiments, at least one of communication component 502, tagging component 504, determining component 506, and memory component 508 may be implemented as non-transient, tangible computer-readable media for carrying or having computer-executable instructions or data structures stored thereon. Such non-transient, tangible computer-readable media can be any available media that can be accessed by a general purpose or special purpose computer. Non-limiting examples of non-transient, tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (hardwired and/or wireless, or a combination of hardwired or wireless) to a computer, the computer properly views the connection as a non-transient, tangible computer-readable media computer-medium. Thus, any such connection is properly termed a non-transient, tangible computer-readable medium. Combinations of the above should also be included within the scope of non-transient, tangible computer-readable media.

Communication bus 509 enables memory communication component 502, tagging component 504, determining component 506, and memory component 508 to communicate with one another.

Memory component 508 is arranged to communicate with determining component via signal 510 along communication bus 509 and to communicate with tagging component 504 via signal 512 along communication bus 509. Determining component 506 is additionally arranged to communicate with communication component 502 via signal 514 along communication bus 509. Tagging component is additionally arranged to communicate with communication component 502 via signal 516 along communication bus 509.

Communication component 502 is arranged and is operable to bi-directionally communicate with communication device 102. Communication component 502 is additionally arranged and is operable to bi-directionally communicate with server 106, server 110, and server 114, via communication network 104. Communication component 502 may communicate by any known communication method and that is able to send a tagged communication by a known communication method, non-limiting examples of which include via: a cellular network, a satellite network, a wireless network, a voice over Internet protocol (VoIP) network, etc.

In some embodiments, communication component 502 is operable to receive a tagged communication from communication device 102, wherein the tagged communication is in a first tagging format and has identification data associated with one user of a first group of users. For example, the user of communication device 102 may send a communication that is tagged for Jenny within group of users 108. Communication component 502 may receive the communication as tagged communication 134.

In some embodiments, communication device 102 and translator/distributor 402 are a unitary device. In such embodiments, communication component 502 is operable to generate a tagged communication in a first tagging format and having identification data associated with one user of a first group of users.

Memory component 508 is operable to store first identification data of first group of users 108, to store second identification data of second group of users 112 and to store third identification data of third group of users 116. The first identification data includes ID data corresponding to each user of first group of users 108, respectively. For example, memory component 508 may store the name, contact information and a tagging format for each user in group of users 108, e.g., for Jenny, which is user 118 for the user account within the social network First Social Network. The second identification data includes ID data corresponding to each user of second group of users 112, respectively. For example, memory component 508 may store the name, contact information, and a tagging format for each user in group of users 112, e.g., for Jenny, which is user 118 for the user account within the social network Third Social Network and for Dana, which is user 124 for the user account within the social network Third Social Network. The third identification data includes ID data corresponding to each user of third group of users 116, respectively. For example, memory component 508 may store the name, contact information, and a tagging format for each user in group of users 116, e.g., for Jenny, which is user 118 for the user account within the social network Second Social Network, and for Betty, which is user 132 for the user account within the social network Second Social Network.

The identification data may be stored in memory component 508 by any known method. In some embodiments, the user of communication device 102 may input the data by way of a registration process. In some embodiments, the user of communication device 102 may provide translator/distributor 402 with authority to access the user accounts for each of servers 106, 110, and 114, wherein translator/distributor 402 may pull the identification data from each server.

Determining component 506 receives tagged communication 134 from communication component 502 via signal 514 along communication bus 509. Determining component 506 is operable to determine whether the person associated with tagged communication 134 is within more than one group of users. In an example embodiment, determining component 506 may access, via signal 510 along communication bus 509, the identification data within memory component 508 to make such a determination.

Tagging component 504 is operable to generate modified tagged communications based on tagged communication 134. In an example embodiment, tagging component 504 may access memory component 508, via signal 512 along communication bus 509, to find all the tags associated with a particular person. Tagging component 504 may then generate any needed modified tagged communications. Any modified tagged communications will be provided, via signal 516 along communication bus 509, to communication component 502.

Communication component 502 is further operable to transmit tagged communication 134 to server 106 and, if needed, to transmit a modified tagged communication to server 110 and to transmit another modified tagged communication to server 114.

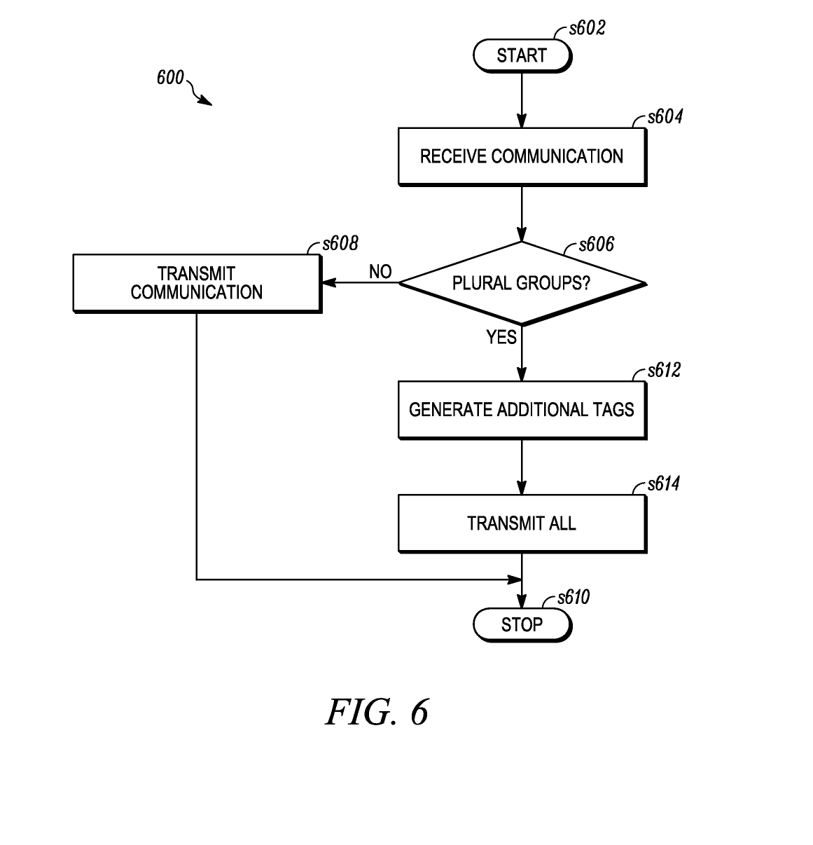

FIG. 6 illustrates an example method of operation of the translator/distributor of FIG. 5.

For this discussion, again consider the situation where the user of user device 102 tags Jenny in a communication to be displayed in the social network corresponding to each of server 106, server 110, and server 114, respectively.

Method 600 starts (S602), and a communication is received (S604). In this case, returning to FIG. 5, communication component 502 receives tagged communication 134 from communication device 102.

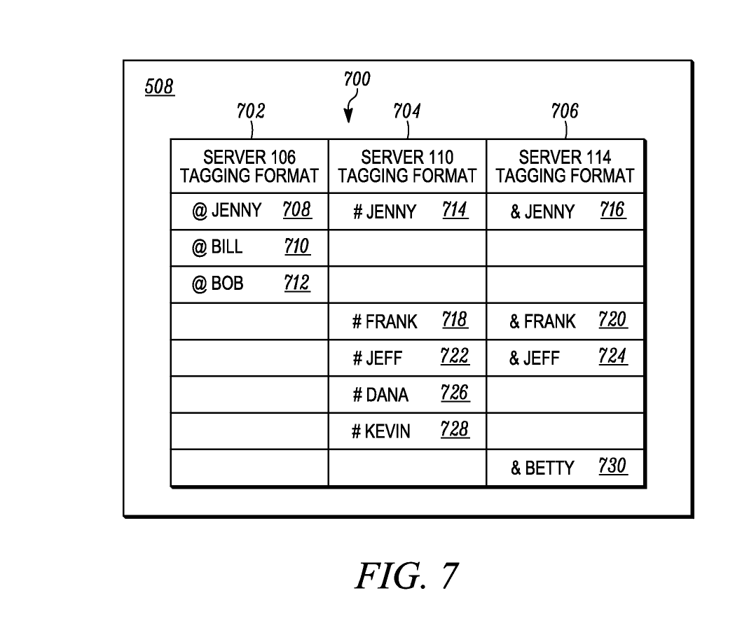

Returning to FIG. 6, it is then determined whether the received communication is to be sent to a plurality of servers having different tagging formats (S606). For example, returning to FIG. 5, determining component 506 receives tagged communication 134, via signal 514 from communication component 502 along communication bus 509. In some embodiments, determining component 506 may access memory component 508 via signal 510 along communication bus 509 to assist in the determination. This will be described in greater detail with reference to FIG. 7.

FIG. 7 illustrates an example memory component of the translator/distributor of FIG. 5.

As shown in FIG. 7, memory component 508 includes a look-up table 700, having column 702, column 704, and column 706. Column 702 includes data entries 708, 710, and 712. Column 704 includes data entries 714, 718, 722, 726, and 728. Column 706 includes data entries 716, 720, 724, and 730.

Column 702 corresponds to the tagging format for friends of the user of communication device 102 within first group of users 108, i.e., the friends corresponding to server 106. Column 704 corresponds to the tagging format for friends of the user of communication device 102 within second group of users 112, i.e., the friends corresponding to server 110. Column 706 corresponds to the tagging format for friends of the user of communication device 102 within third group of users 116, i.e., the friends corresponding to server 114.

In this example, the tagging format for users of server 106 include the “@” symbol. As shown in data entry 708, the tagging format to tag a communication for Jenny is “@Jenny.” As shown in data entry 710, the tagging format to tag a communication for Bill is “@Bill,” whereas in data entry 712, the tagging format to tag a communication for Bob is “@Bob.”

In this example, the tagging format for users of server 110 include the “#” symbol, whereas the tagging format for users of server 114 include the “&” symbol. Because Jenny is a friend of the user of communication device 102 in each of the three social networks, lookup table 700 has an entry corresponding to Jenny for each of corresponding servers. More particularly, as shown in data entry 714, the tagging format to tag a communication for Jenny is “#Jenny,” and as shown in data entry 716, the tagging format to tag a communication for Jenny is “&Jenny.”

Because Frank and Jeff are friends of the user of communication device 102 in only two of the three social networks, look-up table 700 has an entry corresponding to each of Frank and Jeff for each of the corresponding servers. More particularly, as shown in data entry 718, the tagging format to tag a communication for Frank is “#Frank,” and as shown in data entry 720, the tagging format to tag a communication for Frank is “&Frank.” Similarly, as shown in data entry 722, the tagging format to tag a communication for Jeff is “#Jeff,” and as shown in data entry 724, the tagging format to tag a communication for Jeff is “&Jeff.”

User 120, Bill, and user 122, Bob, are friends with the user of communication device 102 in only the social network corresponding to server 106. User 124, Dana, and user 126, Kevin, are friends with the user of communication device 102 in only the social network corresponding to server 110. User 132, Betty, is friends with the user of communication device 102 in only the social network corresponding to server 114″Further, each data entry in look-up table 700 may have identification data associated with its respective user. For example, data entry 708 may have identification data associated with the account of user 118, within the social network First Social Network. This identification data may include address information such that subsequently generated tagged communication will be directed to the correct user. Further, data entries within column 702 may have identification data indicating an association with server 106, such that users listed within column 702 correspond to the group of users 108. Similarly, data entries within column 704 may have identification data indicating an association with server 110, such that users listed within column 704 correspond to the group of users 112. Additionally, data entries within column 706 may have identification data indicating an association with server 114, such that users listed within column 706 correspond to the group of users 116.

Returning to FIG. 5, determining component 506 may determine whether received communication is to be sent to a plurality of servers having different tagging formats if a person is listed in several formats in look-up table 700. For example, if a received communication is to any one of @Jenny, #Jenny or &Jenny, then determining component 506 may determine that the received communication is to be tagged for all corresponding tagging formats for associated with Jenny—in this case, all three tagging formats. Similarly, if a received communication is to any one #Frank or &Frank, then determining component 506 may determine that the received communication is to be tagged for all corresponding tagging formats for associated with Frank—in this case, only two tagging formats. If a received communication is to &Betty, then determining component 506 may determine that the received communication is to be tagged for the only tagging format for Betty.

Returning to FIG. 6, if it is determined that the received communication is not to be sent to a plurality of servers having different tagging formats (NO in S606), then the communication is transmitted (S608) and the process stops (S610). For example, as discussed above, if a received communication is to &Betty, then determining component 506 may determine that the received communication is to be tagged for the only tagging format for Betty. In this sense, the received communication is destined for only a single server, having a single associated tagging format. In such a case, returning to FIG. 5, communication component 502 sends tagged communication 134 as indicated by arrow 404 to server 106.

Returning to FIG. 6, if it is determined that the received communication is to be sent to a plurality of servers having different tagging formats (YES in S606), then additional tags are created (S612). For example, as discussed above, if a received communication is to any one of @Jenny, #Jenny or &Jenny, then determining component 506 may determine that the received communication is to be tagged for all corresponding tagging formats for associated with Jenny—in this case, all three tagging formats. In this sense, the received communication is destined for all three servers, each having an associated tagging format.

Returning to FIG. 5, take the example situation where communication component 502 receives tagged communication 134 as a communication with a tagging format @Jenny. Determining component 506 may access look-up table 700 of memory component 508 via signal 510 along communication bus 509. As shown in FIG. 7, it is clear that user 118 of group of users 108 associated with server 106 uses the tagging format @Jenny. As further noted in look-up table 700, user 118 is also within group of users 112 associated with server 110 uses the tagging format #Jenny and is within group of users 116 associated with server 114 uses the tagging format &Jenny.

Returning to FIG. 5, tagging component 504 therefore generates modified tagged communications for the additional tagging formats. In this case, tagging component 504 accesses memory component 508 via signal 512 along communication bus 509 to find the additional tagging formats. Tagging component 504 then generates a modified tagged communication having a tagging format #Jenny, which corresponds to the original tagged communication 134 having the tagging format @Jenny. Further, tagging component 504 generates another modified tagged communication having a tagging format &Jenny, which corresponds to the original tagged communication 134 having the tagging format @Jenny.

Returning to FIG. 6, after the additional communications having different tagging formats have been created, all the communications are transmitted (S614) and method 600 stops (S610). For example, returning to the example discussed above with reference to FIG. 5, consider the situation where tagging component 504 has generated two additional modified tagged communications. In this situation, tagging component 504 provides the first created modified tagged communication and the second modified tagged communication to communication component 502 via signal 516 along communication bus 509. Communication component 502 transmits tagged communication 134, the first modified tagged communication and the second modified tagged communication, together shown as distributed communication 403, to communication network 104. Distributed communication 403 includes the original received tagged communication 134 as indicated by arrow 404, the first modified tagged communication as indicated by arrow 408, and the second modified tagged communication as indicated by arrow 412. Tagged communication 134 as indicated by arrow 404 is transmitted to server 106, and will have the tagging format associated therewith, which in this example is @Jenny. The first modified tagged communication as indicated by arrow 408 is transmitted to server 110, and will have the tagging format associated therewith, which in this example is #Jenny. The second modified tagged communication as indicated by 412 is transmitted to server 114, and will have the tagging format associated therewith, which in this example is &Jenny.

Returning now to FIG. 4, in accordance with embodiments of the present disclosure, a universal tagging system is provided. User device 102 is able to send a single tagged communication to three separate servers, each having its own distinct tagging format. In this way, user 118 associated with the original tagged communication is notified in any one of their social networks—in this case group of users 108, 112, and 116.

In the embodiment discussed above with reference to FIGS. 4-7, translator/distributor 402 is separate from user device 102. In this situation, communication component 502 is in communication with a communication device, i.e., user device 102. In some embodiments, translator/distributor 402 user device 102 may be a unitary device. In this situation, user device 102 and translator/distributor 402 may be considered a communication component in communication with server 106, server 110, and server 114.

The present disclosure provides a system and method for universally tagging a communication for a plurality of social networks, and adaptable to any social network format.

The foregoing descriptions of various embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

We claim:

1. A device comprising:
a communication component operable to receive a tagged communication from a communication device, the tagged communication being in a first tagging format and having identification data associated with one user of a first group of users;
a memory component operable to store first identification data of the first group of users and to store second identification data of a second group of users, the first identification data including first identification data corresponding to each user of the first group of users, respectively, the second identification data including second identification data corresponding to each user of the second group of users, respectively;
a determining component operable to determine whether the one user of the first group of users has corresponding identification data within the second identification data; and
a tagging component operable to generate a modified tagged communication based on the tagged communication, the modified tagged communication being in a second tagging format,
wherein said communication component is further operable to transmit the tagged communication to a first server and to transmit the modified tagged communication to a second server.

2. The communication device of claim 1, wherein said memory component includes a look-up table.

3. The communication device of claim 2, wherein at least two of said communication component, said memory component, said determining component and said tagging component comprise a unitary device.

4. The communication device of claim 1, wherein at least two of said communication component, said memory component, said determining component and said tagging component comprise a unitary device.

5. A communication device, comprising:
a communication component operable to generate a tagged communication in a first tagging format and having identification data associated with one user of a first group of users;
a memory component operable to store first identification data of the first group of users and to store second identification data of a second group of users, the first identification data including first identification data corresponding to each user of the first group of users, respectively, the second identification data including second identification data corresponding to each user of the second group of users, respectively;
a determining component operable to determine whether the one user of the first group of users has corresponding identification data within the second identification data; and
a tagging component operable to generate a modified tagged communication based on the tagged communication, the modified tagged communication being in a second tagging format,
wherein said communication component is further operable to transmit the tagged communication to a first server and to transmit the modified tagged communication to a second server.

6. The communication device of claim 5, wherein said memory component includes a look-up table.

7. The communication device of claim 6, wherein at least two of said communication component, said memory component, said determining component and said tagging component comprise a unitary device.

8. The communication device of claim 5, wherein at least two of said communication component, said memory component, said determining component and said tagging component comprise a unitary device.

9. A communication method comprising: receiving, via a communication component, a tagged communication in a first tagging format and having identification data associated with one user of a first group of users;
storing, via a memory component, first identification data of the first group of users, the first identification data including first identification data corresponding to each user of the first group of users, respectively;
storing, via the memory component, second identification data of a second group of users, the second identification data including second identification data corresponding to each user of the second group of users, respectively;
determining, via a determining component, whether the one user of the first group of users has corresponding identification data within the second identification data;
generating, via a tagging component, a modified tagged communication based on the tagged communication, the modified tagged communication being in a second tagging format;
transmitting, via the communication component, the tagged communication to a first server; and
transmitting, via the communication component, the modified tagged communication to a second server.

10. The communication method of claim 9
wherein said storing, via a memory component, first identification data of the first group of users, the first identification data including first identification data corresponding to each user of the first group of users, respectively, comprises storing, via the memory component, first identification data in a look-up table, and
wherein said storing, via the memory component, second identification data of a second group of users, the second identification data including second identification data corresponding to each user of the second group of users, respectively, comprises storing, via the memory component, second identification data in the look-up table.

11. A communication method comprising
generating, via a communication component, a tagged communication in a first tagging format and having identification data associated with one user of a first group of users;
storing, via a memory component, first identification data of the first group of users, the first identification data including first identification data corresponding to each user of the first group of users, respectively;
storing, via the memory component, second identification data of a second group of users, the second identification data including second identification data corresponding to each user of the second group of users, respectively;
determining, via a determining component, whether the one user of the first group of users has corresponding identification data within the second identification data;
generating, via a tagging component, a modified tagged communication based on the tagged communication, the modified tagged communication being in a second tagging format;
transmitting, via the communication component, the tagged communication to a first server; and
transmitting, via the communication component, the modified tagged communication to a second server.

12. The communication method of claim 11,
wherein said storing, via a memory component, first identification data of the first group of users, the first identification data including first identification data corresponding to each user of the first group of users, respectively, comprises storing, via the memory component, first identification data in a look-up table, and
wherein said storing, via the memory component, second identification data of a second group of users, the second identification data including second identification data corresponding to each user of the second group of users, respectively, comprises storing, via the memory component, second identification data in the look-up table.
